(19) United States
(12) Patent Application Publication
(10) Pub. No.: US 2006/0002439 A1
(43) Pub. Date: Jan. 5, 2006

(54) Laser output control apparatus and method

(75) Inventor: Jong-min Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics So., Ltd., Suwon-si (KR)

(21) Appl. No.: 11/171,275

(22) Filed: Jul. 1, 2005

(30) Foreign Application Priority Data
Jul. 1, 2004 (KR) 10-2004-0051186

(51) Int. Cl. H01S 3/00

(52) U.S. Cl. 372/38.07; 372/38.02; 372/38.01

(57) ABSTRACT

A laser output control apparatus and method are provided. The laser output control apparatus includes a laser unit including a laser diode and a photo diode having at least one connection structure therebetween; a power controller maintaining power of a laser beam emitted by the laser diode constant in accordance with a feedback voltage applied from the photo diode; and a bias voltage application unit selectively applying a bias voltage to the photo diode according to the connection structure so that the photo diode is biased in a reverse direction. Accordingly, a different bias voltage can be selectively applied to a photo diode according to a connection structure in which a laser diode and the photo diode of a semiconductor laser are connected to each other. Accordingly, it is possible to applicable a semiconductor laser device in office appliance regardless of a connection structure of the semiconductor laser device, thereby allowing versatility of used parts and reducing manufacture costs.

### CROSS-REFERENCE TO RELATED APPLICATIONS

This application claims the benefit of Korean Patent Application No. 10-2004-0051186, filed on Jul. 1, 2004, in the Korean Intellectual Property Office, the disclosure of which is incorporated herein in its entirety by reference.

### BACKGROUND OF THE INVENTION

1. Field of the Invention

The present invention relates to laser output control, and more particularly, to a laser output control apparatus capable of controlling a laser output regardless of a connection structure of a laser diode and a photo diode that constitute a semiconductor laser device.

2. Description of the Related Art

A semiconductor laser device can be extensively applicable to office appliances, such as a laser printer, a laser facsimile, or a multi-functional peripherals, as well as an optical recording medium, such as a Compact Disc Recordable (CD-R), a Compact Disc Rewritable (CD-RW), and a Digital Versatile Disc (DVD). Two semiconductor elements, i.e., a laser diode and a photo diode, are installed in the semiconductor laser device. The laser diode and the photo diode are constructed such that they are biased in a forward direction and a reverse direction, respectively. A semiconductor laser applicable to an optical recording medium generates a laser beam using a continuous wave technique. A connection of a laser diode and a photo diode of the semiconductor laser applicable to an optical recording medium may be variously structured. For instance, an anode of the laser diode and a cathode of the photo diode are commonly connected to each other, a cathode of the laser diode and the cathode of the photo diode are commonly connected to each other, the cathode of the laser diode and an anode of the photo diode are commonly connected to each other, or the anode of the laser diode and the anode of the photo diode are commonly connected to each other. The semiconductor laser device for an optical recording medium is standardized in that the anode of the laser diode and the cathode of the photo diode, or the cathode of the laser diode and the cathode of the photo diode are commonly connected to each other.

A semiconductor laser device applicable to an office appliance generates a laser beam according to a high-speed on/off switching method using a high-frequency pulse. The semiconductor laser device for the office appliance is constructed such that an anode of the laser diode and a cathode of the photo diode are connected to each other as a common electrode. Since only a semiconductor laser device with such a connection is applicable to the office appliance, versatility of used parts is limited, thereby increasing manufacture costs.

### SUMMARY OF THE INVENTION

Additional aspects, features, and/or advantages of the invention will be set forth in part in the description which follows and, in part, will be apparent from the description, or may be learned by practice of the invention.

The present invention provides a laser output control apparatus that is applicable to a semiconductor laser device with at least one connection structure of a laser diode and a photo diode so as to control a laser output thereof.

According to one aspect of the present invention, there is provided a laser output control apparatus including: a laser unit including a laser diode and a photo diode having at least one connection structure therebetween; a power controller maintaining power of a laser beam emitted by the laser diode constant in accordance with a feedback voltage applied from the photo diode; and a bias voltage application unit selectively applying a bias voltage to the photo diode according to the connection structure so that the photo diode is biased in a reverse direction.

According to another aspect of the present invention, there is provided a laser output control apparatus including: a laser unit including a laser diode and a photo diode having at least one connection structure therebetween; a power controller maintaining power of a laser beam emitted by the laser diode constant in accordance with a feedback voltage applied from the photo diode; a bias voltage generator generating at least one bias voltage that makes the photo diode biased in a reverse direction; and a selector selecting a bias voltage, which is to be applied to the photo diode, from at least one bias voltage according to the at least one connection structure.

According to yet another aspect of the present invention, there is provided a laser output control apparatus including: a laser unit constructed according to one of a first connection structure in which a cathode of a laser diode and an anode of a photo diode are commonly connected, and a second connection structure in which the cathode of the laser diode and a cathode of the photo diode are commonly connected; a power controller maintaining power of a laser beam emitted by the laser diode constant in accordance with a feedback voltage applied from the photo diode; a bias voltage generator generating a first bias voltage and a second bias voltage that make the photo diode biased in a reverse direction; and a selector selectively applying one of the first and second bias voltage to the photo diode according to one of the first and second connection structures.

According to yet another aspect of the present invention, there is provided a method for controlling a laser beam emitted by a laser control apparatus, including: providing a laser diode and a photo diode having first and second connection structures therebetween; generating a first bias voltage and a second bias voltage; and selectively applying one of the first and second bias voltage to the photo diode according to one of the first and second connection structures to make the photo diode biased in the reverse direction.

### BRIEF DESCRIPTION OF THE DRAWINGS

These and/or other aspects, features, and advantages of the invention will become apparent and more readily appreciated from the following description of the exemplary embodiments, taken in conjunction with the accompanying drawings of which:

FIG. 1 is a block diagram of a laser output control apparatus according to an exemplary embodiment of the present invention;

FIGS. 2A and 2B illustrate examples of a connection structure of a laser diode and a photo diode that constitute a laser unit of FIG. 1;

FIG. 3 is a circuit diagram of a power controller of FIG. 1 according to an exemplary embodiment of the present invention;

FIG. 4 is a circuit diagram of a bias voltage application unit of FIG. 1 according to an exemplary embodiment of the present invention;

FIG. 5 is a block diagram of a second bias voltage generation unit of FIG. 4 according to an exemplary embodiment of the present invention;

FIG. 6 is a detailed circuit diagram of the second bias voltage generation unit of FIG. 4 according to an exemplary embodiment of the present invention; and

FIGS. 7A through 7F are waveform diagrams of the operations of elements of FIG. 6.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. The exemplary embodiments are described below to explain the present invention by referring to the figures.

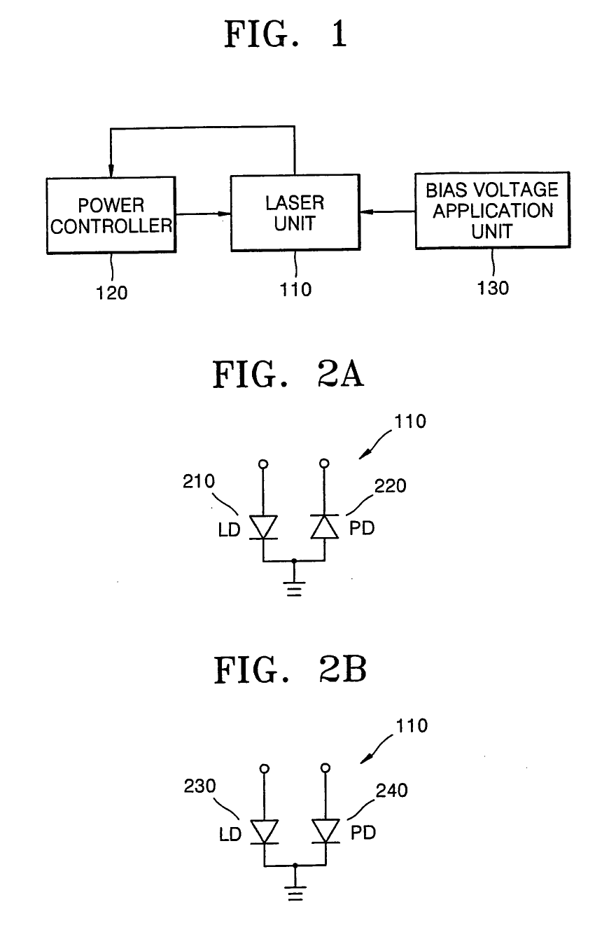

Referring to FIG. 1, a laser output control apparatus according to an exemplary embodiment of the present invention includes a laser unit 110, a power controller 120, and a bias voltage application unit 130.

The laser unit 110 includes a laser diode (LD) acting as a light-emitting unit and a photo diode (PD) acting as a light-receiving unit. A terminal of the LD and a terminal of the PD are commonly connected to each other. Examples of a connection of the LD and the PD that constitute the laser unit 110 will be described with reference to FIGS. 2A and 2B.

A laser unit 110 of FIG. 2A includes an LD 210 that is biased in a forward direction and a PD 220 that is biased in a reverse direction. The laser unit 110 of FIG. 2A has a first connection structure in which a cathode of the LD 210 and an anode of the PD 220 are connected to each other at a common terminal and the common terminal is grounded. In the first connection structure, a feedback voltage detected from a cathode of the PD 220 is applied to the power controller 120 of FIG. 1.

A laser unit 110 of FIG. 2B includes an LD 230 that is biased in a forward direction and a PD 240 that is biased in a reverse direction. The laser unit 110 of FIG. 2B has a second connection structure in which a cathode of the LD 230 and a cathode of the PD 240 are connected to each other at a common terminal and the common terminal is grounded. In the second connection structure, a feedback voltage detected from an anode of the PD 240 is applied to the power controller 120 of FIG. 1.

As in Automatic Power Control (APC), the power controller 120 changes the size of a driving current supplied to the LD according to the size of the feedback voltage applied from the laser unit 110, thereby maintaining the power of a laser beam emitted by the LD constant. The feedback voltage is determined by a monitoring current and a bias voltage. The monitoring current is obtained by converting a laser beam output from the PD with respect to a laser beam output from the LD into a current. The bias voltage is used to make the PD biased in the reverse direction. In the case of the laser unit 110 with the first connection structure (FIG. 2A), the bias voltage is a positive voltage. In the case of the laser unit 110 with the second connection structure (FIG. 2B), the bias voltage is a negative voltage.

The bias voltage application unit 130 applies a bias voltage that makes the PD biased in the reverse direction to the laser unit 110. Whether a positive voltage or a negative voltage is applied to the PD is determined depending on a connection structure of the LD and the PD of the laser unit 110. When the laser unit 110 has the first connection structure shown in FIG. 2A, a voltage obtained by adjusting a positive voltage is applied to the cathode of the PD. When the laser unit 110 has the second connection structure of FIG. 2B, a voltage obtained by adjusting a negative voltage is applied to the anode of the PD.

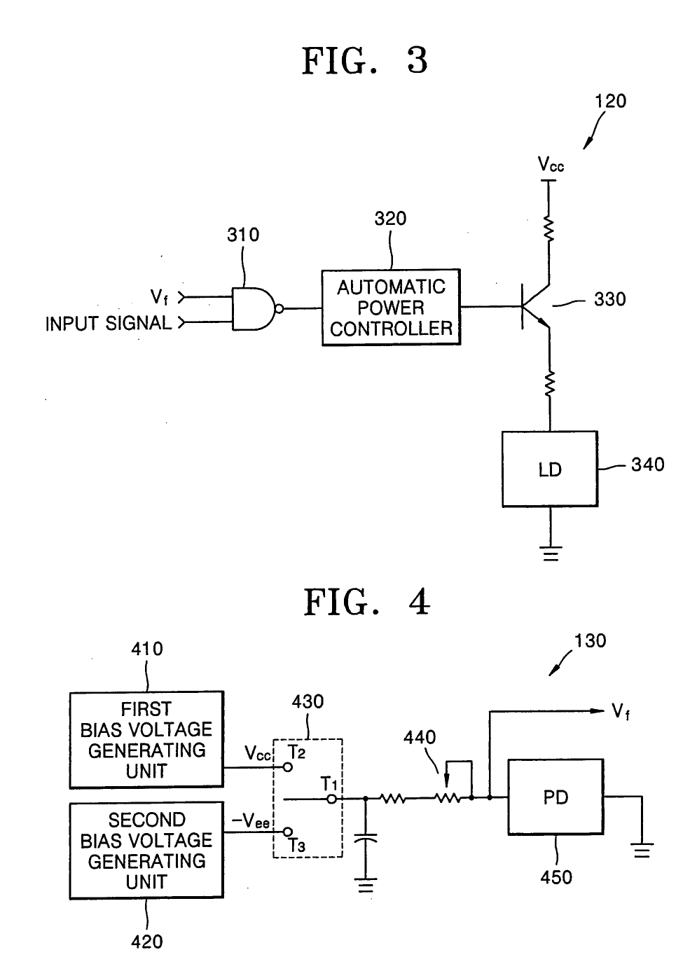

FIG. 3 is a circuit diagram of the power controller 120 of FIG. 1 according to an exemplary embodiment of the present invention. Referring to FIG. 3, the power controller 120 includes a comparator 310, an automatic power controller 320, a driving unit 330, and an LD 340. The comparator 310 compares an input signal and a feedback voltage V_{f}, and provides a control signal representing the result of comparison to the automatic power controller 330. The comparator 310 may be embodied as a NAND gate. When applied to a laser scanning unit, the input signal is image data.

The automatic power controller 320 generates a driving signal having a current and a voltage determined by the control signal and provides the driving signal to the driving unit 330 so as to maintain the power of a laser beam emitted by the LD 340 constant. The automatic power controller 320 may be an Application-Specific Integrated Circuit (ASIC) chip that has been used widely.

The driving unit 330 generates a predetermined driving current in response to the driving signal generated by the automatic power controller 320 and provides the driving current to the LD 340 that is biased in the forward direction. Then, the LD 340 emits a laser beam whose magnitude is proportional to that of the driving current.

FIG. 4 is a circuit diagram of the bias voltage application unit 130 of FIG. 1 according to an exemplary embodiment of the present invention. Referring to FIG. 4, the bias voltage application unit 130 includes a first bias voltage generating unit 410, a second bias voltage generating unit 420, a selector 430, a variable resistor 440, and a PD 450.

When the laser unit 110 of FIG. 1 has the first connection structure shown in FIG. 2A, the first bias voltage generating unit 410 generates a first bias voltage V_{cc} that makes the PD 450 biased in a reverse direction. The first bias voltage V_{cc} is a positive voltage, e.g., a power supply voltage of +5V that is generally applied to a laser scanning unit.

When the laser unit 110 has the second connection structure of FIG. 2B, the second bias voltage generating unit 420 generates a second bias voltage −Vₑₑ that makes the PD 450 biased in a reverse direction. The second bias voltage −Vₑₑ is a negative voltage, e.g., −5V. Since a negative voltage is not applied to the laser scanning unit from an external source, the negative voltage is generated and used in the laser scanning unit.

The selector 430 selects and outputs one of the first bias voltage V_{cc} generated by the first bias voltage generating unit 410 and the second bias voltage −Vₑₑ generated by the second bias voltage generating unit 420. The selector 430 may be embodied as a switch having an output contact point T₁, and first and second input contact points T₂ and T₃. During a manufacture process, the selector 430 may be manipulated in advance according to a connection of the LD and the PD of the laser unit 110. For instance, when the laser unit 110 has the first connection structure, the selector 430 may be installed such that the output contact point T₁ contacts the first input contact point T₂. When the laser unit 110 has the second connection structure, the selector 430 may be installed such that the output contact point T₁ contacts the second input contact point T₃.

The variable resistor 440 generates a feedback voltage V_{f} by dropping the first or second bias voltage in accordance with a monitoring current whose magnitude is proportional to that of a light emitted by the PD 450, and provides it to the power controller 120.

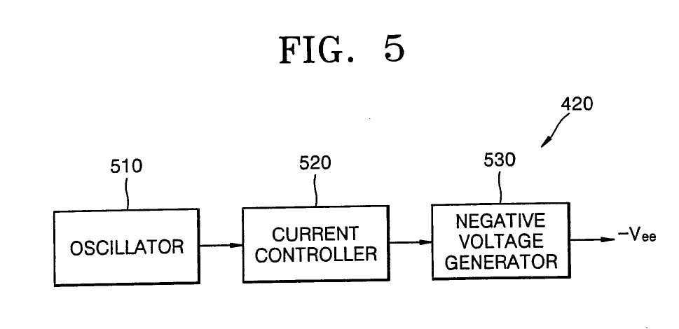

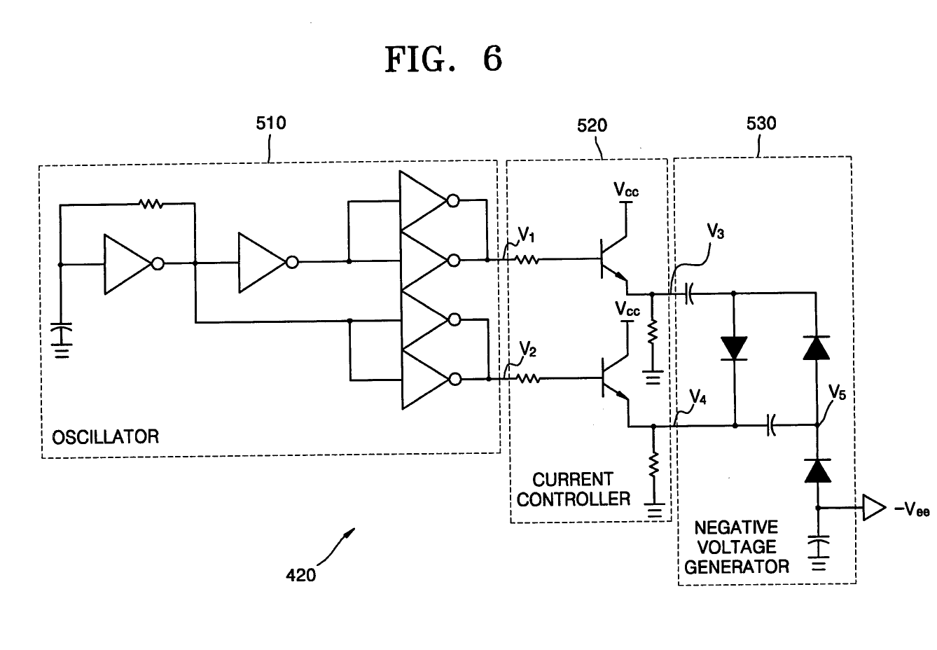

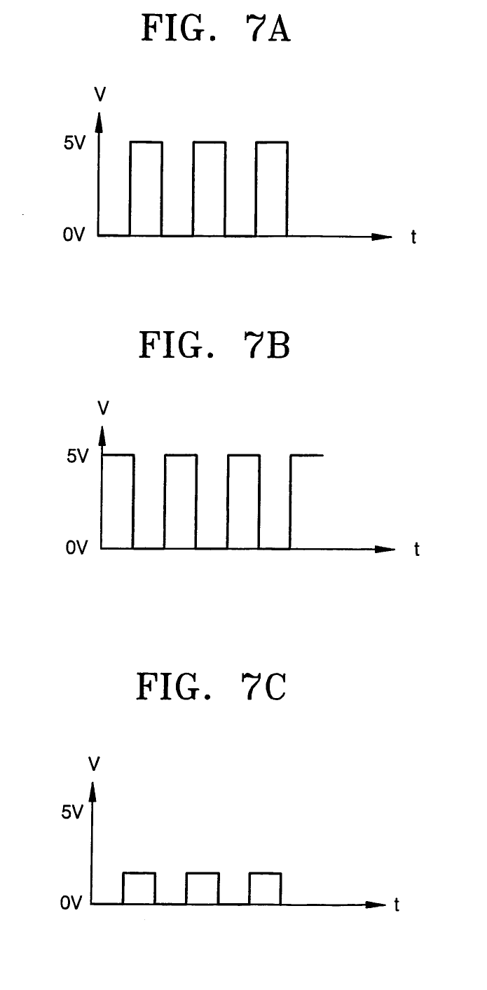

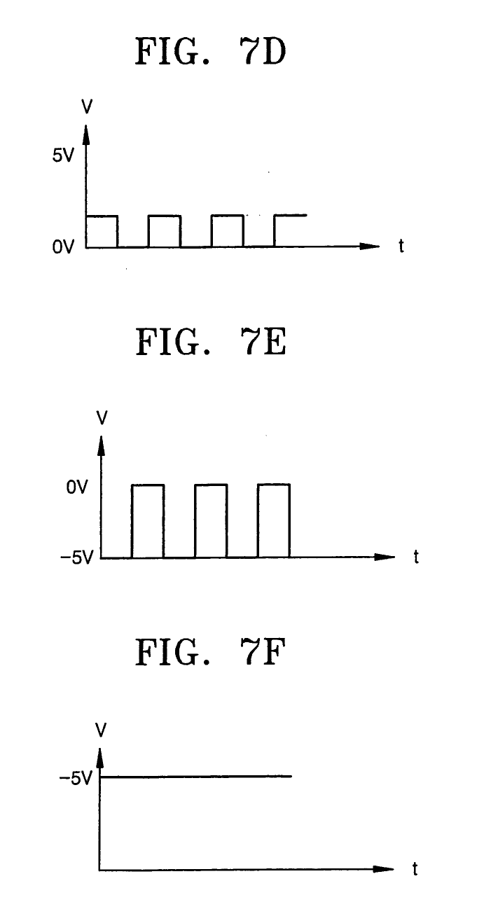

FIG. 5 is a block diagram of the second bias voltage generating unit 420 of FIG. 4 according to an exemplary embodiment of the present invention. Referring to FIG. 5, the second bias voltage generating unit 420 includes an oscillator 510, a current controller 520, and a negative voltage generator 530. The operations of these elements of the second bias voltage generating unit 420 will now be described with reference to FIGS. 6 and 7A through 7F.

The oscillator 510 oscillates at a predetermined oscillation frequency to obtain a first clock signal and a second clock signal with different phases. For instance, the oscillator 510 performs oscillation using a Schmidt trigger circuit such as that shown in FIG. 6 at an oscillation frequency of 22 KHz obtained by adjusting a value of a resistor or a value of a capacitor. Referring to FIG. 6, an oscillator 510 generates a first clock signal V₁ whose waveform is illustrated in FIG. 7A and a second clock signal V₂ whose waveform is illustrated in FIG. 7B. The phase difference between the first clock signal V₁ and the second clock signal V₂ corresponds to 90 degrees.

The current controller 520 generates a third clock signal V₃ and a fourth clock signal V₄ using the first and second clock signals V₁ and V₂ so as to increase the current capacity for the second bias voltage −Vₑₑ. Referring to FIG. 6, a current controller 520 uses two transistors in which the first and second clock signals V₁ and V₂ are input to their base terminals, respectively, and a third clock signal V₃ whose waveform is illustrated in FIG. 7C and a fourth clock signal V₄ whose waveform is illustrated in FIG. 7D are output from their emitter terminals, respectively. In this case, a transistor that has a comparatively high current gain h_{fe} and a comparatively low collector-emitter saturated voltage V_{ce(sat)} with respect to a rated current of the PD 450 actually used, is preferably used.

The negative voltage generator 530 generates a fifth cock signal V₅ with a negative double voltage using the third and fourth clock signals V₃ and V₄ and generates the second bias voltage −Vₑₑ using the fifth cock signal V₅. The waveform of the fifth cock signal V₅ is illustrated in FIG. 7E, and the waveform of the second bias voltage −Vₑₑ is illustrated in FIG. 7F. The fifth cock signal V₅ may be obtained using a charge pumping circuit such as that shown in FIG. 6. The second bias voltage −Vₑₑ may be obtained by rectifying the fifth cock signal V₅ generated by the charge pumping circuit using a diode and a capacitor shown in FIG. 6.

The present invention is not limited by the structure of the second bias voltage generator 420 shown in FIGS. 5 and 6. A negative voltage required by the present invention can be generated using one of various circuits. In this disclosure, the second bias voltage −Vₑₑ of −5V is used for convenience. That is, the second bias voltage −Vₑₑ is not limited, and can be generated using an external negative voltage.

A laser output control apparatus according to the present invention may be installed in a laser scanning unit applicable to office appliance, such as a laser printer, a laser facsimile, or a multi-functional peripherals, that requires high-speed on/off switching.

As described above, in a laser output control apparatus according to the present invention, a different bias voltage is selectively applied to a photo diode according to a connection structure in which a laser diode and the photo diode of a semiconductor laser device are connected to each other. Accordingly, it is possible to use a semiconductor laser device in office appliance regardless of a connection structure of the semiconductor laser, thereby allowing versatility of machine parts and reducing manufacture costs.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A laser output control apparatus comprising:
a laser unit including a laser diode and a photo diode having at least one connection structure therebetween; and
a bias voltage application unit selectively applying a bias voltage to the photo diode according to the connection structure so that the photo diode is biased in a reverse direction.

2. The laser output control apparatus of claim 1, wherein the laser unit is constructed according to one of a first connection structure in which a cathode of the laser diode and an anode of the photo diode are commonly connected, and a second connection structure in which the cathode of the laser diode and a cathode of the photo diode are commonly connected.

3. The laser output control apparatus of claim 2, wherein the bias voltage application unit comprises:
a first bias voltage generating unit generating a first bias voltage that makes the photo diode, which is connected to the laser diode according to the first connection structure, biased in a reverse direction;
a second bias voltage generating unit generating a second bias voltage that makes the photo diode, which is connected to the laser diode according to the second connection structure, biased in the reverse direction; and
a selector selecting one of the first and second bias voltages according to the connection structure of the laser diode and the photo diode.

4. The laser output control apparatus of claim 3, wherein the second bias voltage generating unit comprises:
an oscillator oscillating at a predetermined frequency to obtain a first clock signal and a second clock signal with different phases;
a current controller generating a third clock signal and a fourth clock signal using the first and second clock signals so as to increase the current capacity for the second bias voltage; and
a negative voltage generator generating a fifth clock signal with a negative double voltage using the third and fourth clock signals, and generating the second bias voltage using the fifth clock signal.

5. The laser output control apparatus of claim 1, further comprising a power controller maintaining power of a laser beam emitted by the laser diode constant in accordance with a feedback voltage applied from the photo diode.

6. The laser output control apparatus of claim 5, wherein the bias voltage application unit further comprises a variable resistor generating the feedback voltage by dropping one of the first and second bias voltages selected by the selector in accordance with a monitoring current flowing through the photo diode.

7. The laser output control apparatus of claim 1, which is installed in a laser scanning unit.

8. The laser output control apparatus of claim 5, which is installed in a laser scanning unit.

9. A laser output control apparatus comprising:
a laser unit including a laser diode and a photo diode having at least one connection structure therebetween;
a bias voltage generator generating at least one bias voltage that makes the photo diode biased in a reverse direction; and
a selector selecting a bias voltage, which is to be applied to the photo diode, from at least one bias voltage according to the at least one connection structure.

10. The laser output control apparatus of claim 9, wherein the laser unit is constructed according to one of a first connection structure in which a cathode of the laser diode and an anode of the photo diode are commonly connected, and a second connection structure in which the cathode of the laser diode and a cathode of the photo diode are commonly connected.

11. The laser output control apparatus of claim 9, further comprising a power controller maintaining power of a laser beam emitted by the laser diode constant in accordance with a feedback voltage applied from the photo diode.

12. The laser output control apparatus of claim 9, which is installed in a laser scanning unit.

13. The laser output control apparatus of claim 11, which is installed in a laser scanning unit.

14. A laser output control apparatus comprising:
a laser unit constructed according to one of a first connection structure in which a cathode of a laser diode and an anode of a photo diode are commonly connected, and a second connection structure in which the cathode of the laser diode and a cathode of the photo diode are commonly connected;
a bias voltage generator generating a first bias voltage and a second bias voltage; and
a selector selectively applying one of the first and second bias voltage to the photo diode according to one of the first and second connection structures to make the photo diode biased in a reverse direction.

15. The laser output control apparatus of claim 14, which is installed in a laser scanning unit.

16. The laser output control apparatus of claim 14, further comprising a power controller maintaining power of a laser beam emitted by the laser diode constant in accordance with a feedback voltage applied from the photo diode.

17. The laser output control apparatus of claim 16, which is installed in a laser scanning unit.

18. A method for controlling a laser beam emitted by a laser control apparatus, comprising:
providing a laser diode and a photo diode having first and second connection structures therebetween;
generating a first bias voltage and a second bias voltage; and
selectively applying one of the first and second bias voltages to the photo diode according to one of the first and second connection structures to make the photo diode biased in the reverse direction.

19. The method of claim 18, further comprising maintaining power of the laser beam constant in accordance with a feedback voltage applied from the photo diode.
